(19) United States
(12) Patent Application Publication
(10) Pub. No.: US 2006/0089929 A1
(43) Pub. Date: Apr. 27, 2006

(54) Analysis data processing system and analyzing apparatus

(75) Inventor: Tsuyoshi Morikawa, Kyoto-fu (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Shimadzu Corporation, Kyoto (JP)

(21) Appl. No.: 11/253,600

(22) Filed: Oct. 20, 2005

(30) Foreign Application Priority Data
Oct. 25, 2004 (JP) 2004-309266

(51) Int. Cl. G06F 17/30

(52) U.S. Cl. 707/4

(57) ABSTRACT

The present invention provides a network-capable analysis data processing system and an analyzing apparatus, for which an external client application program or an information-processing system to be used as a counterpart of the communication can be easily developed with smaller amounts of time and labor. According to the present invention, the interface of the server 18 installed in an analyzing apparatus 10 is designed in conformity with generally used technical standards that are free from any limitation prescribed by specific vendors, and a WSDL document 24, in which the server interface is specified in a standard description language, is published to external systems 16. Developers of the external systems 16 can use an existing development tool that automatically creates a communication module 30 from the specification 24. The availability of this communication module 30 will facilitate the development of an application program that communicates with the server 18.

The present invention relates to an analysis data processing system for processing data relating to an analysis carried out with a liquid chromatograph, a gas chromatograph, a mass spectrometer or a similar analyzing apparatus. The “data relating to an analysis” hereby includes a set of parameters used for monitoring and controlling the analyzing apparatus, a set of data obtained by an analysis of a sample using the analyzing apparatus, or any other type of data entered into or retrieved from the analyzing apparatus. The present invention also relates to an analyzing apparatus having the aforementioned analysis data processing system built-in.

### BACKGROUND OF THE INVENTION

A conventional method of monitoring and controlling an analyzing apparatus employs an analysis-controlling application program dedicated for the apparatus concerned to send various parameters and other data to the apparatus, using a dedicated communication protocol. In general, however, the communication protocol and the control parameters change from manufacturer to manufacturer, and from one type of apparatus to another. Therefore, the aforementioned method needs a dedicated analysis control application program to be developed for each manufacturer or each type of apparatus. This development work requires considerable amounts of cost and labor.

In view of such a problem, some conventional analyzing apparatuses are provided with a means that enables the apparatus to be monitored and controlled from a remote terminal over a data communication network, such as a local area network (LAN). Examples of such apparatuses are disclosed in the Japanese Unexamined Patent Publication Nos. 2001-281258 (“Patent Document No. 1”) and 2002-372543 (“Patent Document No. 2”).

The apparatus disclosed in Patent Document No. 1 uses a markup language, such as XML (Extensible Markup Language), to describe system configuration, measurement conditions, maintenance status, operation logs and other information. These pieces of information can be sent to and received from another computer over the network. Use of XML as the description language enables the information to be remotely viewed with a commercially available XML viewer or a similar software application commonly used. The apparatus also includes an online means, which allows the apparatus to have a network connection to an external laboratory information system (LIS) or hospital information system (HIS), or to be subject to remote maintenance operations (monitoring, error recovery and so on) from external computers.

The analyzing apparatus disclosed in Patent Document No. 2 produces the analysis information in a markup language, such as HTML (Hypertext Markup Language), so that the information can be remotely viewed from any terminal having a commercially available web browser. The control program installed in the apparatus is constructed in the form of a CGI (Common Gateway Interface) program, which allows a web browser running on a remote terminal to send control commands to the analyzing apparatus.

The analyzing apparatuses disclosed in the two patent documents send and receive data in a standard format, such as XML or HTML, so that the user can remotely monitor and control the apparatus across a network, using a common browser or viewer. However, in the case where an original client application is to be developed for the monitoring and controlling of the analyzing apparatus, the developer needs to analyze the interface specification of the server program running on the apparatus. This work requires the same amounts of cost and labor as the aforementioned conventional development work.

This problem is particularly serious in the case of developing an information processing system (e.g. a database management system (DBMS) or a laboratory information management system (LIMS)) that should support multiple types of analyzing apparatuses supplied by different vendors. To develop such a multivendor system, the developer should analyze the interface of the server installed in each analyzing apparatus on the basis of the specification supplied by each vendor and create plural communication modules, each module matching the interface of each analyzing apparatus. This work requires considerable amounts of cost and labor because different vendors usually prepare their specifications in different styles. Furthermore, if the specification of any device or system is modified or a new device or system is added, the analyzing system needs to be accordingly maintained or altered. This work also requires considerable amounts of cost and labor.

In light of the above-described problems, the present invention intends to provide a network-capable analysis data processing system and an analyzing apparatus, for which an external client application or an information-processing system to be used as a counterpart of the communication can be easily developed with smaller amounts of time and labor.

### SUMMARY OF THE INVENTION

Thus, the present invention provides an analysis data processing system for processing data relating to an analysis, which includes:

a server for receiving a request message from an external system over a data communication network, for performing a data-processing operation corresponding to the content of the request message, and for sending the external system a response message containing the result of the data-processing operation over the data communication network, and the server includes:

an interface for receiving the request message and sending the response message, using a standard communication protocol and a standard message format; and

a specification publisher for publishing, on the data communication network, the specification of the interface written in a standard description language recognizable to computers.

The present invention also provides an analyzing apparatus having the server of the above-described analysis data processing system built-in.

In an analysis data processing system or an analyzing apparatus including a server for sending or receiving data relating to an analysis to or from an external system, the present invention solves the aforementioned problems by designing the interface of the server in conformity with generally used technical standards that are free from any limitation prescribed by specific vendors, and by publishing the specification of the interface described in a standard description language.

To send a request message to a server and receive a desired response message from the server, it is necessary to know the interface specification of the server. The specification includes the network address (e.g. uniform resource locator, or URL), the communication protocol to be used, the format of the request message, the format of the response message and other kinds of information relating to the communication performed by the server. According to the present invention, the interface specification of the server is written in a standard description language and published to external systems. This reduces the amounts of cost and labor required for analyzing the interface specification in comparison to the conventional case where each specification is written in a different style specific to each vendor.

The server installed in the analysis data processing system or the analyzing apparatus according to the present invention should be preferably designed in conformity with the standards and protocols relating to the so-called “Web Service.” For example, HTTP (Hypertext Transfer Protocol) may be used as the “standard communication protocol” in the present invention. Similarly, SOAP (Simple Object Access Protocol) or HTTP-POST/GET may be adopted as the “standard message format”, and WSDL (Web Services Description Language) as the “standard description language.” There exist a large number of software resources (libraries, modules, tools and so on) that support these Web Service standards. Developers can use these software resources to efficiently develop a system or apparatus according to the present invention.

According to the present invention, the interface specification is described in a language recognizable to computers. It contains a necessary and sufficient set of information to develop a software module (e.g. a class or library) for sending a request message to the server and extracting necessary information from a response message received from the server. This specification provides a basis for building a tool that automatically (or semi-automatically) creates a software module which is in conformity with the interface specification. Use of WSDL as the description language will particularly improve the efficiency of the system development work because it allows the developer to use an existing software tool that automatically creates a communication module (called the “proxy” or “stub”) from a given WSDL document. It will also reduce the amounts of cost and labor for the maintenance work of the system. For example, in the case where the interface specification has been modified, the developer needs only to obtain a new WSDL document and passes it to the aforementioned tool, which in turn will automatically create a new version of the communication module.

Taking an analyzing apparatus as an example, the following description details a process of developing an application using a WSDL document.

Firstly, the vendor of the analyzing apparatus prepares a WSDL document and publishes it on a server. This document specifies, in WSDL, various data types (e.g. classes or data structures) and methods for entering control parameters, analysis conditions, analysis schedules and other setting data into the analyzing apparatus, and for retrieving raw data obtained from the analysis, meta data, log data and other data relating to the result of the analysis from the analyzing apparatus.

To develop an analysis control application, a data analysis application, a DBMS, an LIMS or any other external system that sends and receives data to and from the analyzing apparatus, the developer needs to implement an interface for communicating with the analyzing apparatus. In this implementation work, the developer obtains the aforementioned WSDL document from the server running on the analyzing apparatus and passes it to an existing development tool, which automatically creates a communication module. In this step, the developer doesn't need to write any program code relating to the data types or methods necessary for the communication with the server, or he or she needs to write only a small amount of such code. Instead, the built-in data types and methods of the automatically created communication module can be used to implement the user interface of the system or the functions (or methods) for collecting raw data, meta data and other data from the server.

SOAP and WSDL use XML as the description language. Therefore, their data structure can be defined by an XML Schema. This XML Schema may be also published to enable external systems to verify the data structure and/or the value range of an input data sent to the server or an output data received from the server.

In the case where the present invention is applied to an analyzing apparatus controlled by an embedded central processing unit (CPU) or a real-time operating system, it is important to minimize the process load resulting from communications with external systems. For this purpose, the server interface should have the simplest possible structure. In a preferable example, the server uses a server program that communicates with external systems according to the HTTP protocol, and the server program receives or sends a SOAP message containing the request or response formatted in XML.

Thus, according to the present invention, the interface of the server installed in an analysis data processing system or an analyzing apparatus is designed in conformity with generally used technical standards (HTTP, SOAP and so on) that are free from any limitation prescribed by specific vendors, and the interface specification written in a standard description language (e.g. WSDL) is published to external systems. This will improve the efficiency of developing external systems that should operate in association with the analysis data processing system or the analyzing apparatus according to the present invention.

### BRIEF DESCRIPTION OF THE DRAWINGS

FIG. 1 is a block diagram of an embodiment of an analyzing system including an analyzing apparatus according to the present invention.

FIG. 2 is an example of the SOAP request message.

FIG. 3 is an example of the SOAP response message.

FIG. 4 is a block diagram of an embodiment of an analyzing system including an analysis data processing system according to the present invention.

### DETAILED DESCRIPTION OF PREFERRED EMBODIMENTS

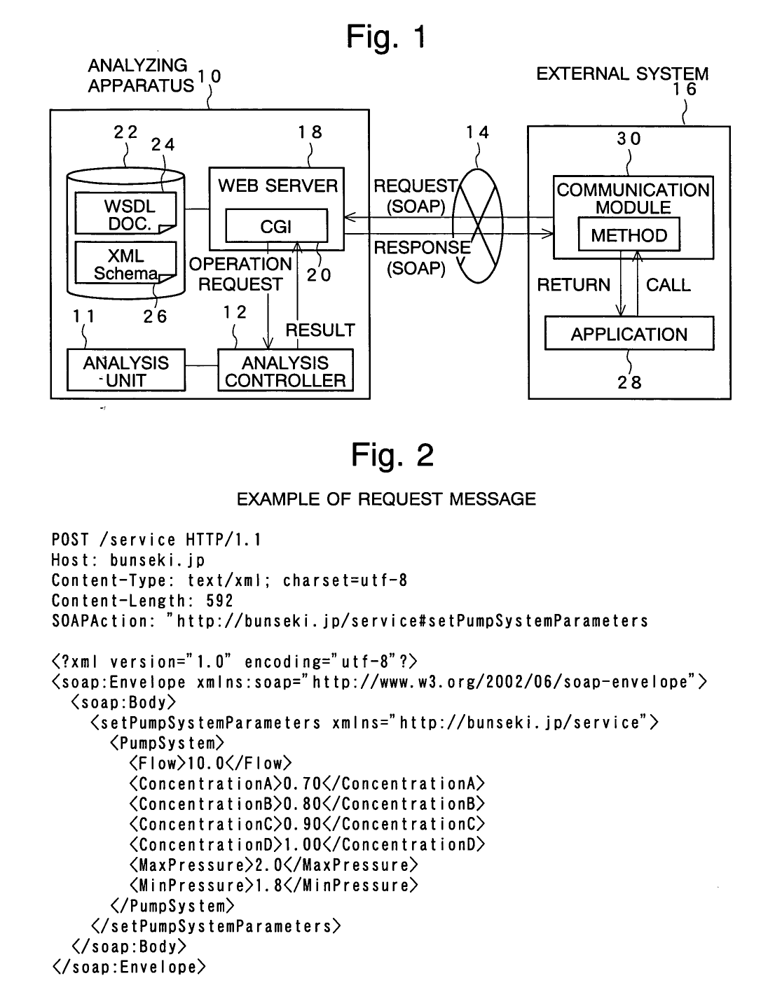

An embodiment of an analyzing system including an analyzing apparatus according to the present invention is described with reference to FIG. 1.

The analyzing system 10 shown in FIG. 1 includes the following components: an analyzing unit 11 for analyzing a sample; an analysis controller 12 for controlling the operation of the analyzing unit 11; a web server 18 for communicating with an external system 16 over a network 14 (e.g. LAN), using HTTP; a CGI program 20 for carrying out various data-processing operations upon receiving requests from the web server 18 and returning the result of the operation to the web server 18; and a document storage unit 22 composed of a hard disk, a memory and/or a similar device. The web server 18 and the CGI program 20 are running on an embedded operating system (OS) installed in the analyzing apparatus 10.

The document storage unit 22 holds a WSDL document 24 and an XML Schema 26. The WSDL document 24 defines methods for setting or retrieving the apparatus-controlling parameters, analysis conditions and analysis schedules, and methods for collecting raw data, meta data and log data. The XML Schema 26 defines the data types of the apparatus-controlling parameters, the analysis conditions, the analysis schedules, the raw data, the meta data and the log data.

The external system 16 is a personal computer connected to the network 14, on which a monitoring and controlling application 28 for the analyzing apparatus 10 is running. The communication module 30 is a software component having data types and methods built-in for the communication with the web server 18. For example, if the operating system of the external system 16 is a version of Microsoft® Windows® Operating System, the communication module 30 can be implemented as a dynamic link library (DLL) in which necessary data types and methods are packaged. The communication module 30 can be automatically created from the WSDL document 24 by a specific development tool. This “automatic creation” process minimally produces a source code written in a predetermined programming language (e.g. C++, Visual Basic® or C#) from the WSDL document 24. The developer of the application 28 compiles the created source code with a compiler to obtain the communication module 30 in the form of a DLL file, and copies this file to a predetermined location (i.e. a folder) within the external system 16. Examples of the tools for creating a source code of a proxy DLL from a WSDL document includes “wsdl.exe”, a program executed from a command line interface, and “Visual Studio® .NET”, a product of Microsoft Corporation. It is naturally allowable to use a fully automatic development tool that can create not only the source code but also the DLL file.

The analyzing apparatus 10 and the external system 16 in the present embodiment operate as follows:

(1) The user operates the user interface of the application 28 to carry out a predetermined operation corresponding to the desired function. Examples of the operation follow:

### EXAMPLE 1

Set the apparatus-controlling parameters on the Control Parameters Setting window, and press the Submit button.

### EXAMPLE 2

Press the button that shows the Analysis Status Information window.

(2) In response to the above operation, the application 28 accesses the communication module 30 and calls a method corresponding to the operation concerned. For example, it may be the method for setting the apparatus-controlling parameters, the method for setting analysis conditions, the method for obtaining analysis status information or the method for collecting raw data of the analysis. With the method call, the application 28 creates an instance of a predetermined class (or a data structure) containing a set of information to be sent to the web server 18, if necessary, and passes the class to the method as its argument. Examples of the class to be passed as the argument include a class for holding the values of the apparatus-controlling parameters and a class for holding values that specify the analysis conditions.

(3) Invoked by the method call, the communication module 30 creates a SOAP request message containing the information held by the class, and sends it to the web server 18, using the HTTP protocol.

(4) Upon receiving the request message, the web server 18 executes the CGI program 20.

(5) The CGI program 20 parses the request message, determines what is requested, and sends the analysis controller 12 a request for operation. This request contains instructions about the operation to be performed. It may also include one or more parameter values if the operation needs such values.

(6) In response to the request for operation, the analysis controller 12 performs the requested operation. For example, it may set control parameters for the analyzing unit 11, set analysis conditions, check the status of the analyzing unit 11, or collect raw data obtained through the analysis.

(7) When the operation is finished, the analysis controller 12 returns the result of the operation to the CGI program 20. The content of the operation result corresponds to the method called earlier. For example, the operation result may contain a value indicating whether the control parameters or the analysis conditions have been successfully set, an error code indicative of the error type if an error has occurred, a set of values representing the status of the analyzing unit 11, or a set of raw data obtained through the analysis.

(8) After receiving the operation result, the CGI program 20 creates a SOAP response message containing the operation result and passes it to the web server 18.

(9) The web server 18 forwards the received message to the communication module 30, using the HTTP protocol.

(10) Upon receiving the response message, the communication module 30 extracts the information about the operation result, stores it into an instance of a predetermined class (or a data structure), and returns the instance (or the data structure) to the application 28 as the return value of the method called earlier.

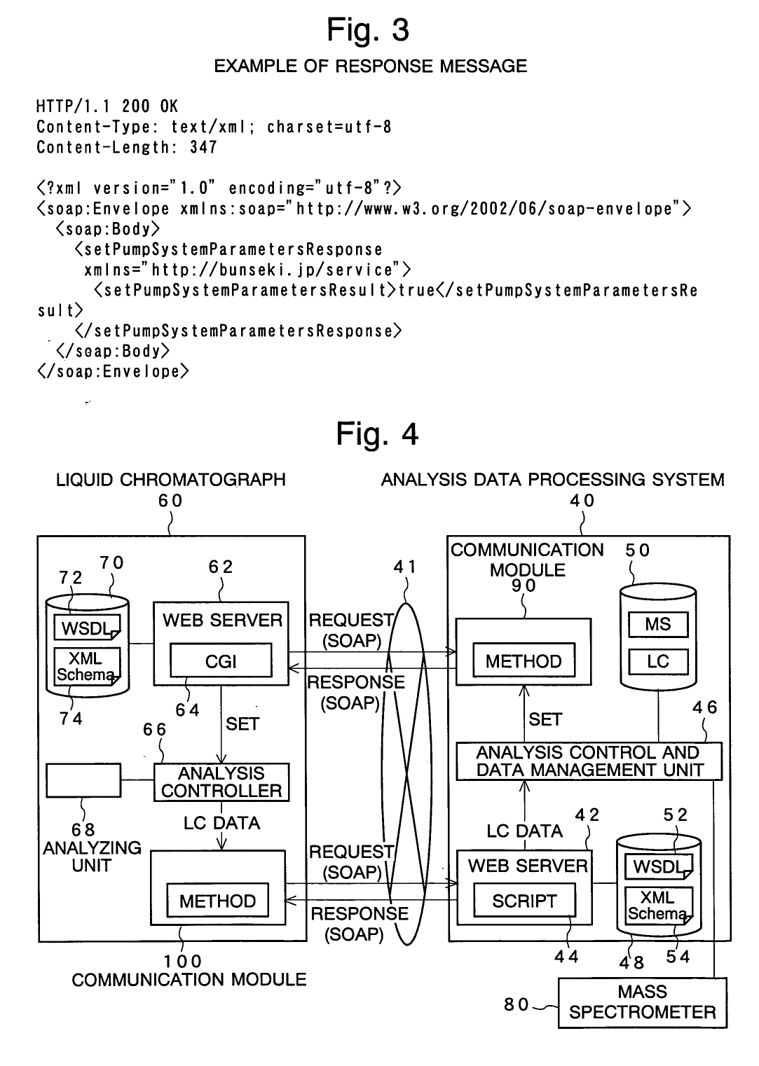

FIGS. 2 and 3 show examples of the SOAP request and response messages transferred between the communication module 30 and the web server 18. As shown in these figures, the request message and the response message are formatted in XML. The data types of the parameters used in these messages and the constraints on these parameters, such as the value range allowed for each parameter, are defined in the XML Schema 26. This Schema 26 provides the basis for verifying the setting values contained in the arguments of each method, the request message, the response message or the return value of the method. Either the application 28 or the CGI program 20 can perform such verification.

An embodiment of an analyzing system including an analysis data processing system according to the present invention is described with reference to FIG. 4. The analyzing system shown in FIG. 4 is mainly composed of an analysis data processing system 40, a network 41, a liquid chromatograph 60 and a mass spectrometer 80.

The analysis data processing system 40 includes a web server 42, a server side script 44 (called the “script 44” hereinafter), a communication module 90, an analysis control and data management unit 46, a document storage unit 48 and an analysis data storage unit 50.

The web server 42 executes the script 44 to send and receive SOAP messages to and from an external system (i.e. the communication module 100 of the liquid chromatograph 60 in the present case), using the HTTP protocol. The interface of the web server 42 is defined in a WSDL document 52 stored in the document storage unit 48. The data types of the parameters transferred with the SOAP messages and the constraints on these parameters, such as the value range allowed for each parameter, are defined in the XML Schema 54.

The analysis control and data management unit 46 stores into the analysis data storage unit 50 the MS data received from the mass spectrometer 80 and the LC data received from the liquid chromatograph 60. It also retrieves necessary data from the analysis data storage unit 50 in response to an instruction from the web server 42. In the analysis data storage unit 50, each piece of LC data is associated with each piece of MS data.

The liquid chromatograph 60 has a web server 62, a CGI program 64, a communication module 100, an analysis controller 66, an analyzing unit 68 and a document storage unit 70.

Cooperating with the CGI program 64, the web server 62 sends and receives SOAP messages to and from an external system (i.e. the communication module 90 of the analysis data processing system 40 in the present case), using the HTTP protocol. The interface of the web server 62 is defined in the WSDL document 72 stored in the document storage unit 70. The data types of the parameters transferred with the SOAP messages and the constraints on these parameters, such as the value range allowed for each parameter, are defined in the XML Schema 74.

The analysis controller 66 performs various operations on the analyzing unit 68 according to an instruction from the CGI program 64. For example, it may set control parameters, check the operation status or collect analysis data.

In the analyzing system shown in FIG. 4, both the analysis data processing system 40 and the liquid chromatograph 60 can function as a server. The following description assumes that the analysis data processing system 40 functions as the server for the liquid chromatograph 60 working as the client.

The analyzing system shown in FIG. 4 is capable of sending (or exporting) analysis data (i.e. the LC data obtained with the liquid chromatograph 60) to the analysis data processing system 40 according to the following steps:

(1) In the liquid chromatograph 60, when the analyzing unit 68 has finished an analysis, the analysis controller 66 collects the LC data (containing the raw data, meta data and log data) obtained through the analysis and passes the data to the communication modules 100.

(2) The communication module 100 creates a SOAP request message containing the LC data received from the analysis controller 66, and sends the message to the web server 42 of the analysis data processing system 40, using the HTTP protocol.

(3) Upon receiving the request message, the web server 42 executes the script 44 to extract the LC data from the request message, and passes the data to the data management unit 46.

(4) The data management unit 46 stores the received LC data into the analysis data storage unit 50, associating the LC data with the corresponding piece of MS data, and returns the result of the data-storing operation (“success” or “error”) to the script 44.

(5) The script 44 receives the operation result and sends the return value to the web server 42. Then, with the help of a library for handling SOAP messages, the web server 42 creates a SOAP response message containing the operation result, and sends it to the communication module 100 of the liquid chromatograph 60, using the HTTP protocol.

It should be understood that the above-described embodiments are mere examples of the analyzing apparatus or the analysis data processing system according to the present invention. For example, the embodiments may be modified as follows:

### MODIFIED EXAMPLE 1

In the above-described embodiments, the CGI program is capable of parsing and creating SOAP messages, whereas the server side script does not have such capabilities. Alternatively, it is possible to provide the script with such capabilities instead of the CGI program.

### MODIFIED EXAMPLE 2

In the above-described embodiments, every message is transferred in the form of a SOAP message. In this case, one or more servers capable of processing the SOAP header may be additionally employed as repeaters. This enables the distributed processing of the data, or allows the data to be transferred to a remotely located data management system.

### MODIFIED EXAMPLE 3

In the first embodiment, the application developer builds a proxy DLL file from the WSDL document with a development tool and copies the file to a predetermined location within the external system 16. This is the so-called “static binding” method, in which the proxy DLL statically resides in the system. Alternatively, it is possible to adopt the “dynamic binding” method, in which the communication module newly retrieves the WSDL document on every access to the server and dynamically creates the proxy DLL from the WSDL document.

### MODIFIED EXAMPLE 4

In the embodiment shown in FIG. 4, the liquid chromatograph 60 can act as the server. Therefore, it is possible that the analysis data processing system 40 initially sends a data transfer request to the liquid chromatograph 60, in response to which the liquid chromatograph 60 exports the LC data. In this case, the analysis data processing system 40 uses the communication module 90 created from the WSDL document 72 of the liquid chromatograph 60 and copied to a predetermined location within the analysis data processing system 40.

It should be noted that the present invention can be embodied in a variety of forms within the sprit and scope thereof.

What is claimed is:

1. An analysis data processing system for processing data relating to an analysis, comprising:
a server for receiving a request message from an external system over a data communication network, for performing a data-processing operation corresponding to a content of the request message, and for sending the external system a response message containing a result of the data-processing operation over the data communication network, and the server includes:
an interface for receiving the request message and sending the response message, using a standard communication protocol and a standard message format; and
a specification publisher for publishing, on the data communication network, a specification of the interface written in a standard description language recognizable to computers.

2. The analysis data processing system according to claim 1, wherein the server is designed in conformity with standards and protocols relating to the Web Service.

3. The analysis data processing system according to claim 2, wherein the standard communication protocol is an HTTP protocol.

4. The analysis data processing system according to claim 2, wherein the standard message format is a SOAP format.

5. The analysis data processing system according to claim 2, wherein the standard message format is an HTTP-POST/GET format.

6. The analysis data processing system according to claim 2, wherein the standard description language is WSDL.

7. The analysis data processing system according to claim 6, further comprising a software tool for automatically creating a communication module from a WSDL document.

8. The analysis data processing system according to claim 2, wherein the specification publisher publishes an XML Schema that defines a data structure necessary for the communication with the server.

9. The analysis data processing system according to claim 2, wherein the server uses a server program that communicates with the external system according to an HTTP protocol, and the server program receives or sends a SOAP message containing the request or response formatted in XML.

10. An analyzing apparatus, comprising:
a server for receiving a request message from an external system over a data communication network, for performing a data-processing operation corresponding to a content of the request message, and for sending the external system a response message containing a result of the data-processing operation over the data communication network, and the server includes:
an interface for receiving the request message and sending the response message, using a standard communication protocol and a standard message format; and
a specification publisher for publishing, on the data communication network, a specification of the interface written in a standard description language recognizable to computers.

11. The analyzing apparatus according to claim 10, wherein the server is designed in conformity with standards and protocols relating to the Web Service.

12. The analyzing apparatus according to claim 11, wherein the standard communication protocol is an HTTP protocol.

13. The analyzing apparatus according to claim 11, wherein the standard message format is a SOAP format.

14. The analyzing apparatus according to claim 11, wherein the standard message format is an HTTP-POST/GET format.

15. The analyzing apparatus according to claim 11, wherein the standard description language is WSDL.

16. The analyzing apparatus according to claim 15, further comprising a software tool for automatically creating a communication module from a WSDL document.

17. The analyzing apparatus according to claim 11, wherein the specification publisher publishes an XML Schema that defines a data structure necessary for the communication with the server.

18. The analyzing apparatus according to claim 11, wherein the server uses a server program that communicates with the external system according to an HTTP protocol, and the server program receives or sends a SOAP message containing the request or response formatted in XML.
